(19) United States
(12) Patent Application Publication
(10) Pub. No.: US 2012/0286443 A1
(43) Pub. Date: Nov. 15, 2012

(54) DETECTION APPARATUS, DETECTION METHOD, AND IMPRINT APPARATUS

(75) Inventor: Hiroshi Sato, Utsunomiya-shi (JP)

(73) Assignee: CANON KABUSHIKI KAISHA, Tokyo (JP)

(21) Appl. No.: 13/452,625

(22) Filed: Apr. 20, 2012

(30) Foreign Application Priority Data
May 10, 2011 (JP) 2011-105633

(51) Int. Cl. B29C 59/02; B28B 17/00; G01B 11/26

(52) U.S. Cl. 264/40.5; 356/508; 425/150

(57) ABSTRACT

A detection apparatus determines an amount of relative rotational deviation between two different objects. Each of the objects has a respective grating mark which together form a pair of grating marks. The detection apparatus includes a detector that detects interference fringes produced by an overlap between the pair of grating marks. The detection apparatus also includes a calculation unit that determines the amount of relative rotational deviation between the two different objects from inclination of the interference fringes detected by the detector. The detection apparatus can be applied, for example, in controlling transfer of a pattern formed on a mold to a transfer material applied to a substrate.

### BACKGROUND OF THE INVENTION

1. Field of the Invention

The present invention relates to a detection apparatus for measuring an amount of rotational deviation between two different objects, and a detection method thereof.

2. Description of the Related Art

Imprint technology is a technique of pressing a mold as a master having a fine pattern against a transfer material applied to a substrate such as a silicon wafer and a glass plate, thereby transferring the pattern to form a fine pattern.

A mold and a substrate are aligned by using a detection apparatus which measures the amount of deviation between a mark formed on the mold and a mark formed on the substrate. In particular, a measurement method using a moiré signal is useful since such a measurement method can achieve high measurement precision with a simple optical system. Japanese Unexamined Patent Publication No. 2008-509825 discusses an imprint apparatus that uses the moiré mark as an alignment mark.

To measure the amount of deviation between the substrate and the mold, parallel movement errors along an X-axis and a Y-axis have been measured separately.

An imprint apparatus produces a deviation between the mold and the substrate due to contact between the mold and the transfer material applied to the substrate. According to Japanese Unexamined Patent Publication No. 2008-509825, a shift deviation between the mark on the mold and the mark on the substrate can be measured.

However, to measure a rotational deviation, a plurality of locations needs to be measured for a shift deviation between the mark on the mold and the mark on the substrate. A rotational deviation therefore takes along time to measure.

### SUMMARY OF THE INVENTION

The present invention is directed to a detection apparatus, a detection method, and an imprint apparatus which measures a rotational deviation between two different objects in a measurement time shorter than heretofore.

According to an aspect of the present invention, a detection apparatus is configured to determine an amount of relative rotational deviation between two different objects, each of the objects having a respective grating mark which together form a pair of grating marks. The detection apparatus includes a detector configured to detect interference fringes produced by an overlap between the pair of grating marks. The detection apparatus also includes a calculation unit configured to determine the amount of relative rotational deviation between the two different objects from inclination of the interference fringes detected by the detector.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an imprint apparatus according to a first exemplary embodiment.

FIG. 2 is a diagram illustrating a detection apparatus according to the first exemplary embodiment.

FIG. 3A is a diagram illustrating a mark formed on a mold according to the first exemplary embodiment.

FIG. 3B is a diagram illustrating a mark formed on a substrate according to the first exemplary embodiment.

FIG. 3C is a diagram illustrating the marks on the mold and the marks on the substrate according to the first exemplary embodiment.

FIG. 3D is a diagram illustrating the marks on the mold and the marks on the substrate according to the first exemplary embodiment.

FIG. 3E is a diagram for describing a method for determining the inclination of the mark from the intervals of lines according to the first exemplary embodiment.

FIG. 4A is a diagram illustrating a grating mark according to a second exemplary embodiment.

FIG. 4B is a diagram illustrating a grating mark according to the second exemplary embodiment.

FIG. 4C is a diagram illustrating a moiré signal according to the second exemplary embodiment.

FIG. 4D is a diagram illustrating a moiré signal according to the second exemplary embodiment.

FIG. 4E is a diagram illustrating a mark arranged in a checkerboard pattern according to the second exemplary embodiment.

FIG. 5A is a diagram illustrating a rotational deviation between a mold and a substrate according to the second exemplary embodiment.

FIG. 5B is a diagram illustrating a rotational deviation between a mold and a substrate according to the second exemplary embodiment.

FIG. 6A is a diagram illustrating a moiré signal according to the second exemplary embodiment in the presence of a rotational deviation.

FIG. 6B is a graph illustrating light intensity of the moiré signal according to the second exemplary embodiment.

FIG. 6C is a diagram for describing a method for determining a rotational deviation according to the second exemplary embodiment.

FIG. 7 is a flowchart illustrating a sequence for performing alignment between a mold and a substrate according to the second exemplary embodiment.

FIG. 8A is a diagram illustrating moiré signals according to a third exemplary embodiment.

FIG. 8B is a diagram illustrating moiré signals according to the third exemplary embodiment.

FIG. 9 is a flowchart illustrating a sequence for performing alignment between a mold and a substrate according to the third exemplary embodiment.

### DESCRIPTION OF THE EMBODIMENTS

Various exemplary embodiments, features, and aspects of the invention will be described in detail below with reference to the drawings.

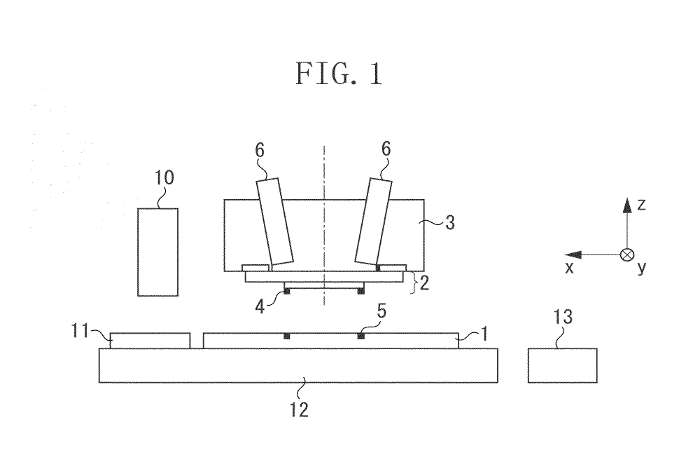

A first exemplary embodiment will be described. FIG. 1 is a diagram illustrating an imprint apparatus that includes a detection apparatus according to the first exemplary embodiment of the present invention. As illustrated in FIG. 1, the imprint apparatus including the detection apparatus according to the present exemplary embodiment includes a substrate stage 12 and an imprint head 3. The substrate stage 12 holds a substrate 1. The imprint head 3 holds a mold 2 on which a pattern is formed.

The imprint head 3 includes scopes 6 (detectors). Each scope 6 can optically detect a mark 4 formed on the mold 2 and a mark 5 formed on the substrate 1. The marks 4 and 5 are a pair of mutually corresponding marks. A not-illustrated calculation unit can determine the amount of deviation between the mold 2 and the substrate 1 from a measurement of the amount of deviation between the two detected marks 4 and 5. During imprinting, a not-illustrated light source irradiates the substrate 1 with exposure light through the mold 2 for the sake of curing resin. To secure an optical path for the exposure light, the scopes 6 are inclined with respect to the mold 2 as illustrated in FIG. 1. If the scopes 6 are movable, the scopes 6 need not be included and may be situated vertical. Such scopes 6 can be moved out of the optical path of the exposure light during exposure.

As employed here, the amount of deviation includes both the amount of rotational deviation and the amount of positional shift. The amount of rotational deviation refers to the magnitude of deviation in the direction of rotation about a direction perpendicular to a plane of the substrate 1 (or mold 2). The amount of positional shift refers to the magnitude of deviation of a shift made within the plane of the substrate 1 (or mold 2). In an exemplary embodiment of the present invention, the scope 6 detects the pair of marks including the mark 4 on the mold 2 and the mark 5 on the substrate 1. The amount of rotational deviation between the marks 4 and 5 is determined from the detection result. The amount of rotational deviation between the mold 2 and the substrate 1 is determined from the resulting amount of rotational deviation between the pair of marks 4 and 5. Since the amount of rotational deviation between the pair of marks 4 and 5 corresponds to that between the mold 2 and the substrate 1, the amount of rotational deviation between the pair of marks 4 and 5 may be simply employed as that between the mold 2 and the substrate 1.

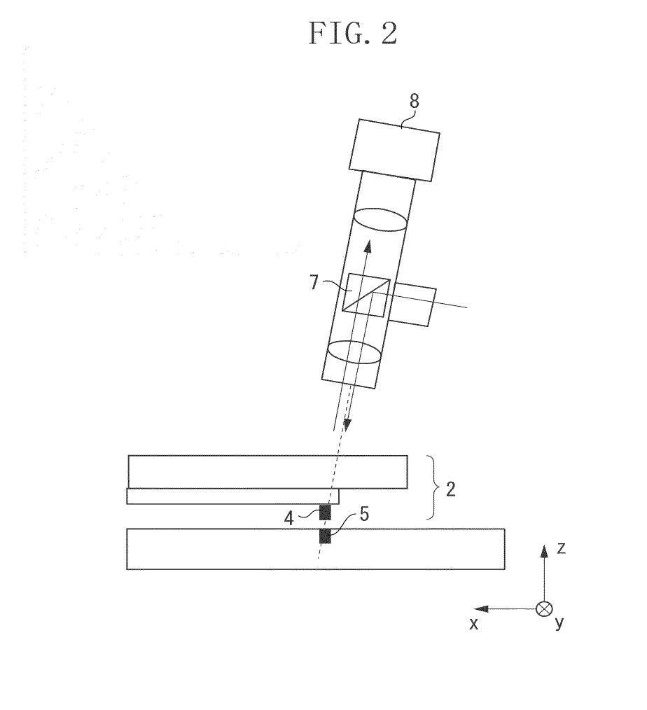

The scope 6 will be described in detail with reference to FIG. 2. The scope 6 guides light from a not-illustrated light source onto the same axis as that of a detection optical system via a half prism 7, and irradiates marks 4 and 5 with the light. The scope 6 includes an image sensor 8. Reflected light from the marks 4 and 5 passes through the prism 7 and forms an image on the image sensor 8. In an exemplary embodiment of the present invention, the marks 4 and 5 whose images are formed on a detection area of the image sensor 8 (detector)) are simultaneously detected to determine the amount of deviation therebetween. In FIG. 2, the y direction corresponds to a measurement direction to be described below, the x direction a non-measurement direction to be described below.

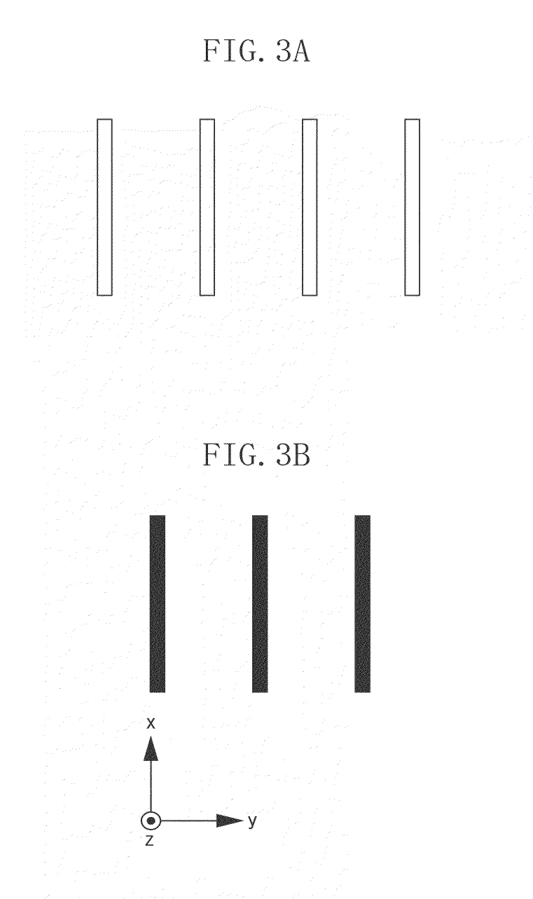

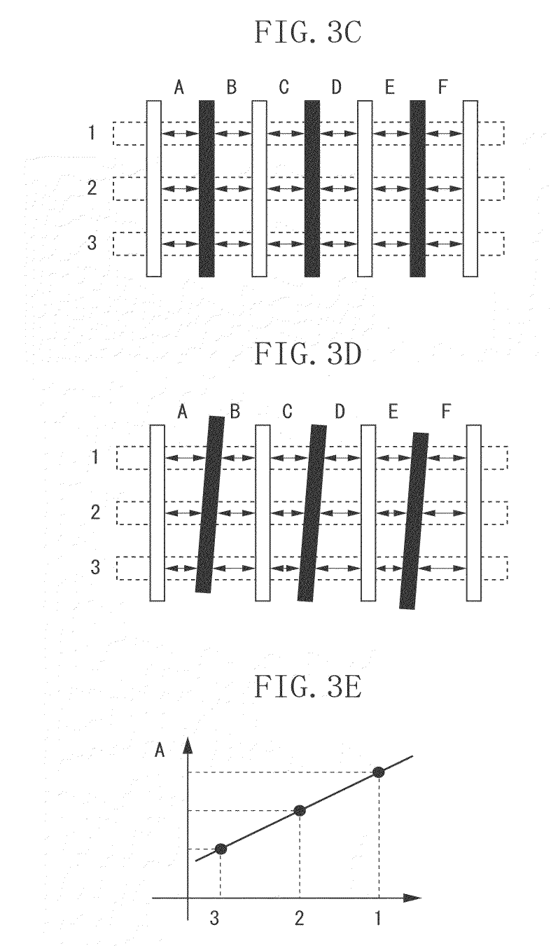

A method of detecting a mark 4 formed on the mold 2 and a mark 5 formed on the substrate 1 and a method of determining the amount of deviation between two detected marks 4 and 5 will be described with reference to FIGS. 3A to 3E. As illustrated in FIGS. 3A and 3B, marks each including lines extending at regular intervals are provided. As employed herein, the direction in which lines extend at regular intervals like FIGS. 3A and 3B is referred to as a non-measurement direction (x direction). A direction perpendicular to the non-measurement direction is referred to as a measurement direction (y direction).

FIG. 3A illustrates a mark that includes four lines. FIG. 3B illustrates a mark that includes three lines. The number of lines arranged in the measurement direction is not limited to those of the present exemplary embodiment, and may be set arbitrarily. In the present exemplary embodiment, the mark of FIG. 3A will be described as the mark 4 formed on the mold 2 and the mark of FIG. 3B as the mark 5 formed on the substrate 1. However, the marks are interchangeable.

A method of detecting marks 4 and 5 with the scope 6 and aligning the mold 2 and the substrate 1 will be described. In order for the scope 6 to detect the marks 4 and 5 at a time (simultaneously), the mold 2 and the substrate 1 are positioned so that the two marks 4 and 5 come close to each other and lie within the depth of focus of the scope 6. If there are a plurality of marks 4 on the mold 2 and a plurality of marks 5 on the substrate 1, the mold 2 and the substrate 1 are positioned so that at least a pair of marks 4 and 5 lie within the depth of focus of the scope 6.

The marks 4 and 5 can thus be simultaneously detected by the scope 6. FIG. 3C is a schematic diagram illustrating the marks 4 and 5 detected by the scope 6 here. The intervals measured between the marks 4 and 5 when the marks 4 and 5 are simultaneously detected will be denoted by A to F, respectively. As illustrated in FIG. 3C, positions in the non-measurement direction (x direction) where the intervals A to F are measured will be referred to as measurement line 1, measurement line 2, and measurement line 3, respectively. Measurement lines 1 to 3 may be pixel rows on the image sensor 8 or detection areas having a certain size.

The marks 4 and 5 are designed so that the marks 4 and 5 detected by the scope 6 have a desired positional relationship when the mold 2 and the substrate 1 are properly aligned. For example, the mark illustrated in FIG. 3A and the mark illustrated in FIG. 3B may be designed to have lines at the same intervals. In such a case, all the intervals A to F become equal if the mold 2 and the substrate 1 are properly aligned.

If the intervals A to F are equal like FIG. 3C, the marks 4 and 5 are positioned as designed and thus the mold 2 and the substrate 1 are properly aligned. If the marks 4 and 5 are misaligned, the relationship between the intervals A to F differs from that of the designed values, like A<B. In such a case, where the proper designed values are A=B, the relative position between the mold 2 and the substrate 1 can be corrected by moving at least either one of the mold 2 and the substrate 1 in a direction of decreasing the interval B.

For example, if the intervals A, C, and E are smaller than the intervals B, D, and F, then the marks 4 and 5 have a deviation in position in the measurement direction. In order to align the relative positions by aligning the positions of marks 4 and 5, the mold 2 on which the mark 4 is formed may be moved so that the intervals A to F become equal. Alternatively, the substrate 1 on which the mark 5 is formed may be moved instead. Further, both the mold 2 and the substrate 1 may be moved to align relative positions.

The foregoing description has dealt with the case where there is a shift deviation in the measurement direction. Next, a case where there is a rotational deviation between the mold 2 and the substrate 1 will be described. If there is a rotational deviation between the mold 2 and the substrate 1, the marks 4 and 5 produce a rotational deviation when the two marks 4 and 5 are detected by the scope 6. FIG. 3D illustrates the marks 4 and 5 detected by the scope 6 in the presence of such a rotational deviation.

In the state of FIG. 3D, the image sensor 8 of the scope 6 detects the intervals A to F between the marks 4 and 5 at different positions on the straight lines (measurement lines 1 to 3) in the measurement direction. A comparison of the intervals measured at different positions on measurement lines 1 to 3 shows that the intervals vary with position.

For example, FIG. 3E illustrates the relationship between detected intervals A and the positions of the lines on which the intervals A are detected. When the marks 4 and 5 are detected in such positions, the interval A varies with the different positions of measurement lines 1 to 3 in the non-measurement direction. This shows that the marks 4 and 5 have a rotational deviation therebetween. The positions of the lines on which the marks 4 and 5 are detected and the distances between the lines are known according to pixels of the image sensor 8. The intervals between the lines are determined by the scope 6 detecting the two marks 4 and 5. A relationship such as illustrated in FIG. 3E can be determined from the intervals of the lines. The gradient of the straight line that connects the measurements indicates the amount of rotational deviation between the mold 2 and the substrate 1. The gradient of the straight line thus determined may be stored as the amount of rotational deviation between the two marks 4 and 5 into the detection apparatus or into an apparatus that controls the detection apparatus.

A rotational deviation between the mold 2 and the substrate 1 is corrected based on the resulting amount of rotational deviation. An example of a correction method includes correcting a rotational deviation by moving the mold 2 or the substrate 1 to rotate so that the intervals between the marks 4 and 5 detected in different positions of measurement lines 1 to 3 at each position A to F become equal. Both the mold 2 and the substrate 1 may be moved to rotate for the correction of a rotational deviation. The amount of rotational deviation determined between the mold 2 and the substrate 1 does not always coincide with the amount of rotational deviation to be actually corrected between the mold 2 and the substrate 1. The reason is that the marks 4 and 5 may have a rotational deviation component beforehand when a pattern formed on the mold 2 and a shot formed on the substrate 1 are properly aligned. In such a case, a difference between the amount of rotational deviation determined by an exemplary embodiment of the present invention and the amount of rotational deviation that the marks 4 and 5 have beforehand corresponds to the actual amount of rotational deviation between the pattern on the mold 2 and the shot on the substrate 1.

The present exemplary embodiment has dealt with the case where the marks 4 and 5 include lines that are arranged at equal intervals in the measurement direction. However, the marks 4 and 5 may include lines at respective different intervals. The lines of the marks 4 and 5 need not be arranged at regular intervals. FIG. 1 illustrates a control unit 13 which is connected to the detection apparatus. The foregoing measurement of the amount of rotational deviation from two detected marks 4 and 5 and the correction of a rotational deviation may be performed by the control unit 13.

As described above, a shift deviation in the measurement direction between the mold 2 and the substrate 1 can be measured by detecting the mark 4 formed on the mold 2 and the mark 5 formed on the substrate 1 simultaneously, and in addition, the amount of rotational deviation can be measured. Based on the measurements, a deviation including a shift deviation and a rotational deviation between the marks 4 and 5 can be corrected to align the mold 2 and the substrate 1. Since the amount of rotational deviation (angular deviation) between the mold 2 and the substrate 1 can be determined from the amount of rotational deviation between a pair of marks 4 and 5, it is possible to reduce the measurement time.

A second exemplary embodiment will be described. In the first exemplary embodiment, the mark 4 formed on the mold 2 and the mark 5 formed on the substrate 1 are such that the lines of the marks 4 and 5 have sufficiently large intervals, both the marks 4 and 5 can be simultaneously observed, and the intervals can be measured. According to the foregoing measurement method, a not-illustrated calculation unit calculates the amount of rotational deviation between the two marks 4 and 5 by using signals whose images are formed on the image sensor 8 through an imaging optical system. This requires a high-resolution scope. High-resolution scopes are large in size since a high numerical aperture (NA) is needed when the high-resolution scope is used. It is difficult to arrange large scopes in the vicinity of the imprint head 3 which holds a mold 2. In view of this, the present exemplary embodiment describes a method of measuring a rotational deviation with high precision even by using a low-resolution, small scope.

The present exemplary embodiment deals with a detection apparatus that detects interference fringes produced by an overlapping between marks 4 and 5. Both the marks 4 and 5 are grating marks. An imprint head 3 includes the scope 6 which detects the light intensity of interference fringes between the marks 4 and 5. The detected light intensity of the interference fringes can be measured to measure the amount of deviation between the marks 4 and 5. The amount of deviation between the marks 4 and 5 can be measured to determine the positional relationship between the mold 2 and the substrate 1. The imprint apparatus of FIG. 1 and the scope 6 of FIG. 2 described in the first exemplary embodiment may be used in the present exemplary embodiment.

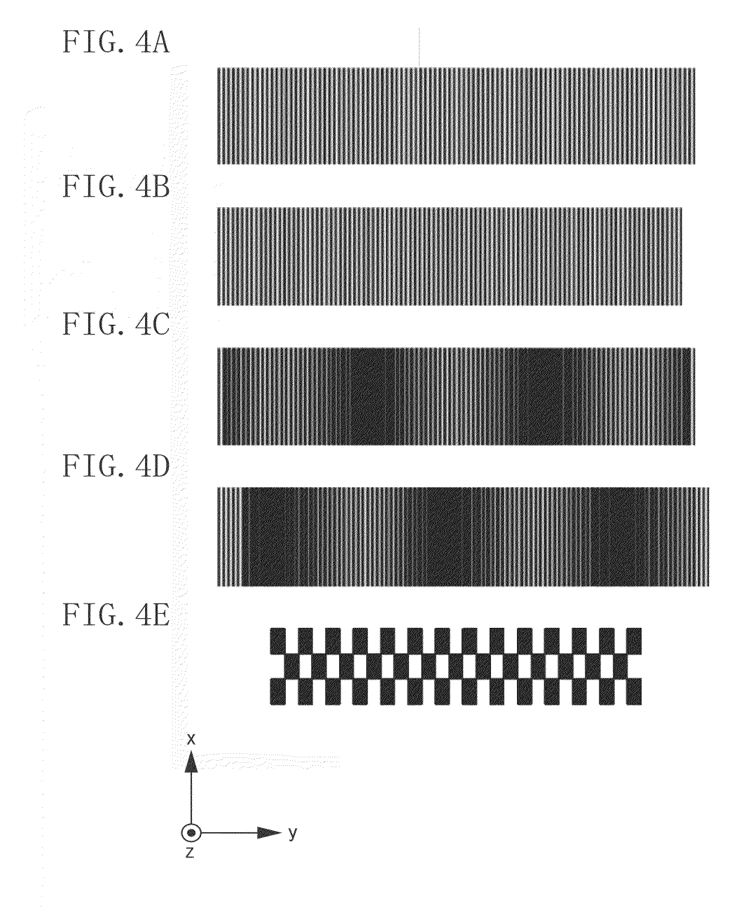

A method of measuring two grating marks 4 and 5 for the amount of deviation between the two marks 4 and 5 will be described with reference to FIGS. 4A to 4E. Two types of grating marks having respective different pitches as illustrated in FIGS. 4A and 4B are prepared. The grating marks 4 and 5 used in an exemplary embodiment of the present invention each include a plurality of lines arranged at regular intervals. The two marks 4 and 5 are a pair of mutually corresponding marks. Like the first exemplary embodiment, the direction in which the lines extend at regular intervals in FIGS. 4A and 4B will be referred to as a non-measurement direction (x direction). A direction perpendicular to the non-measurement direction will be referred to as a measurement direction (y direction). When the two grating marks 4 and 5 are placed to overlap, there occur light and dark interference fringes as illustrated in FIG. 4C. Such interference fringes constitute a moiré signal. Light and dark positions of a moiré signal vary depending on a shift deviation between the mark of FIG. 4A and the mark of FIG. 4B. For example, when at least either one of the marks 4 and 5 is slightly shifted in the y direction, the light and dark pattern of the moiré signal changes as illustrated in FIG. 4D. Such a moiré signal appears as a shift of a large light and dark pattern that magnifies the actual amount of shift between the marks 4 and 5. The amount of positional shift between the two grating marks 4 and 5 can thus be precisely measured even by a low-resolution scope 6. The magnitude of the amount of positional shift is determined by a moiré magnification to be described later.

In an exemplary embodiment of the present invention, as illustrated in FIG. 1, an additional high-precision scope 10 may be arranged in an area adjacent to the imprint head 3. The high-precision scope 10 is intended to perform global alignment when the scopes 6 fail to make a satisfactory measurement. The foregoing moiré signal may be used for calibration in global alignment. Initially, the amount of deviation between a reference mark 11 mounted on the substrate stage 12 and the mark 4 formed on the mold 2 is measured by using the scope 6. Subsequently, the control unit 13 drives the substrate stage 12 so that the reference mark 11 comes under the high-precision scope 10, and measures the reference mark 11 through the high-precision scope 10. Here, a device (not illustrated) that measures the amount of drive of a stage with high precision, such as an interferometer, can be used to measure the amount of drive of the substrate stage 12. This enables measurement of the distance (i.e., baseline amount) between the mold 2 and the high-precision scope 10. Using the resulting baseline amount and the result of global alignment, the control unit 13 repeats an imprint operation shot by shot.

The scopes 6 used in the imprint apparatus are slightly inclined as described above. The linear, one-dimensional diffraction grating mark illustrated in FIG. 4A fails to return light to such scopes 6. A mark 5 on the substrate 1 is thus arranged in a checkerboard pattern (checkered pattern) illustrated in FIG. 4E to constitute a single diffraction grating mark. The diffraction grating has a staggered pattern with a shift as much as the line width. A mark 4 may be a diffraction grating mark illustrated in FIG. 4A. Such adjustment of the mark pitches in the x direction can control the angle of diffraction for inclined measurement. The moiré signal can be obtained with precision equivalent to when the diffraction grating marks 4 and 5 are perpendicularly measured.

A measurement is performed based on a moiré signal by using the marks of FIGS. 4A and 4B as marks 5 formed around a shot on the substrate 1 and marks 4 formed on the mold 2. According to an exemplary embodiment of the present invention, marks (a pair of marks 4 and 5) in one location can be detected to determine whether the mold 2 has an xy shift deviation and/or a rotational shift with respect to a shot on the substrate 1 at the time of imprinting. Measurements as to a plurality of marks 5 arranged around a shot may be integrated for improved precision.

Now, consider the case of measuring marks arranged on four corners of a shot for alignment. In order to detect the positions of the shot in an X direction and a Y direction, two marks 5 are formed on each corner.

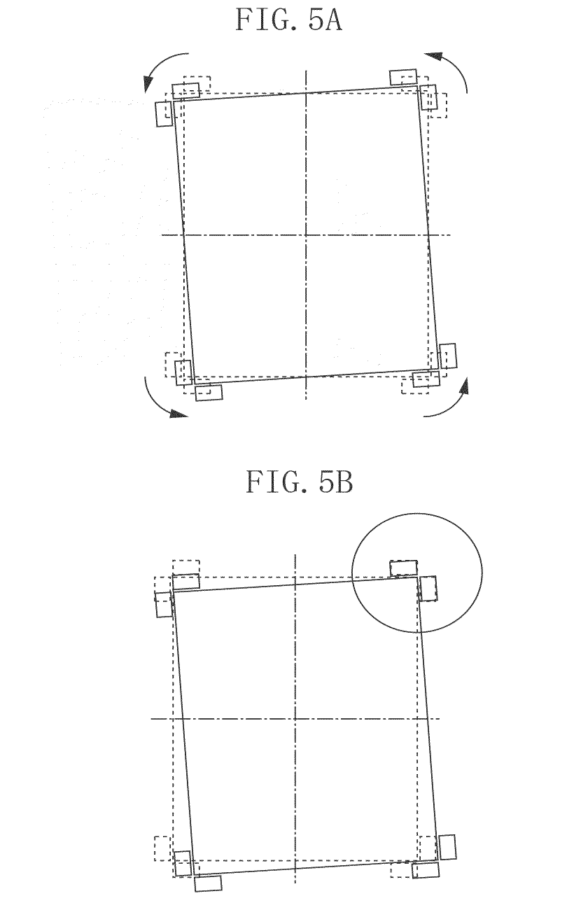

FIG. 5A is a diagram illustrating a state where either one of the mold 2 and a shot on the substrate 1 is rotated with a rotational deviation. In such a case, the marks 4 and 5 in each mark position produce a rotational deviation, and it is not possible to make a measurement for alignment based on moiré interference.

Possible reasons for a rotational deviation include an attachment error of the mold 2 with respect to the imprint head 3 and that a pattern is formed on the mold 2 with a rotation. Possible reasons on the substrate side include a mounting error with which the substrate 1 is mounted on the substrate stage 12 and a manufacturing error of a pattern that is previously formed on the substrate 1 in a prior process. In other words, the pattern formed on the mold 2 may have a relative rotational deviation with respect to the shot on the substrate 1 even if the mold 2 is aligned.

Then, marks 4 and 5 are detected in order one by one for rough measurement, and the mark 5 on the substrate 1 and the mark 4 on the mold 2 are placed to overlap so that the marks 4 and 5 can be simultaneously detected and measured by the scope 6. As employed herein, such a measurement will be referred to as a rough inspection. For example, such a rough inspection is performed to bring the state illustrated in FIG. 5A into the state illustrated in FIG. 5B where the upper right corners are matched.

As illustrated in FIG. 5B, when the marks 4 and 5 at the upper right corner are matched and the mold 2 and the substrate 1 have a rotational deviation, the marks 4 and 5 on the other corners become not measurable. Then, in a next location to measure, marks 4 and 5 are further detected in order one by one for a rough inspection. In such a manner, the matching of marks 4 and 5 on the mold 2 and the substrate 1 is repeated from one corner to another. The detection of marks 4 and 5 by such a method will lead to low throughput, so that the productivity is reduced.

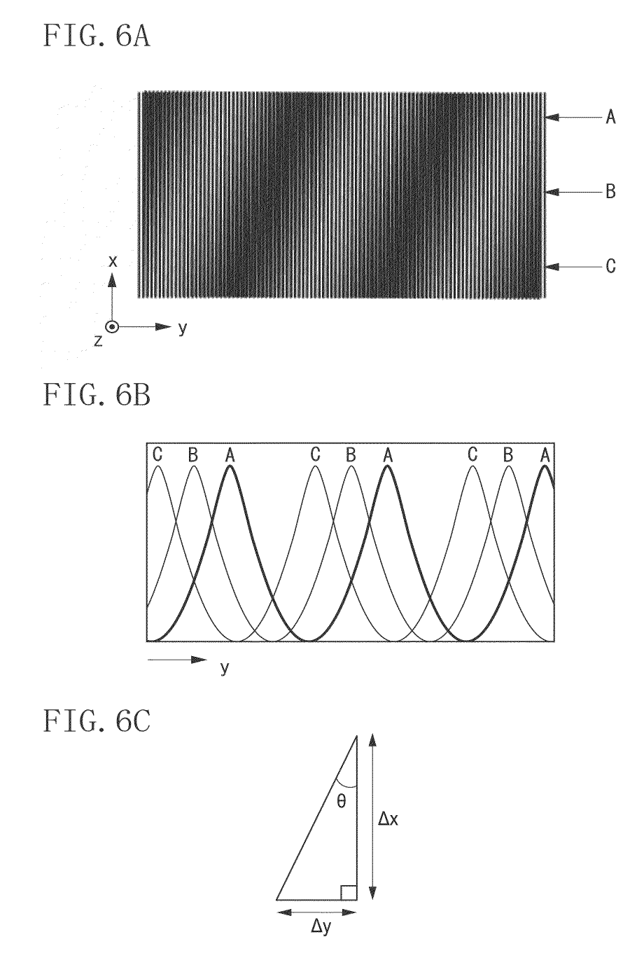

To address this, a technique for calculating the amount of rotational deviation from a detected moiré signal and correcting the amount of rotational deviation will be described. In the present exemplary embodiment, as illustrated in FIG. 5B, at least a pair of marks 4 and 5 are placed to overlap if there are a plurality of marks 4 and 5 on the substrate 1 and the mold 2. The pair of overlapping marks 4 and 5 are detected to determine the amount of relative rotational deviation between the substrate 1 and the mold 2. FIG. 6A illustrates a moiré signal when marks 4 and 5 have a rotational deviation therebetween. FIG. 6B is a graph illustrating signal intensities in positions A, B, and C of FIG. 6A, respectively. The horizontal axis of FIG. 6B indicates the y direction of the moiré signal, and the vertical axis indicates the light intensity of the moiré signal. The bright areas where the light intensity is high represent peaks of the graph and represent peaks of the moiré signal. The dark areas where the light intensity is low represent bottoms of the graph. It can be seen that bright and dark positions vary with the position in the x direction. Such differences in the light intensity depending on the position in the non-measurement direction (x direction) can be measured to determine the amount of rotational deviation.

A method of determining the amount of rotational deviation between the mold 2 and the substrate 1 will be described in detail with reference to FIG. 6C. FIG. 6C illustrates a right triangle that is derived from values detected at two points of the moiré signal acquired in FIGS. 6A and 6B. For example, suppose that the two detection points are a peak of the interference fringes in the position A and a peak of the interference fringes in the position C. In FIG. 6C, Δx represents a difference between the positions in the non-measurement direction (x direction) where the moiré signal is measured. In terms of FIG. 6A, Δx corresponds to the difference between the positions A and C in the x direction. The moiré signal appears as a shift that magnifies the actual amount of shift between the marks 4 and 5 as much as a moiré magnification given by equation (1) seen below. A measurement value is thus calculated in consideration of the moiré magnification.

$$moiré magnification = \frac{{P}_{1} + {P}_{2}}{{P}_{1} - {P}_{2}} \qquad ( 1 )$$

Where P₁ and P₂ are the pitches of the marks 4 and 5, respectively. The pitches are known from design values of the marks 4 and 5. Δy corresponds to a shift of the moiré signal. The amount of deviation of the light and dark of the moiré signal is determined at the measurement positions that are set when determining Δx. For example, in terms of the graph illustrated in FIG. 6B, the shift may be a distance between peaks (bright points) of the light intensity signal. The shift may be a distance between bottoms (dark points).

The lengths of the two sides in FIG. 6C are thus known. The amount of rotational deviation θ between the mold 2 and the substrate 1 can be determined by the following equation (2):

$$θ = {tan}^{- 1} ( \frac{Δ y}{Δ x} ) \qquad ( 2 )$$

If an image sensor 8 is a two-dimensional charge-coupled device (CCD), the outputs from pixels at desired positions can be used to determine the amount of rotational deviation θ between the mold 2 and the substrate 1. When a moiré signal such as illustrated in FIG. 6A is detected on the CCD, or the image sensor 8, the outputs from pixels at positions corresponding to the positions A and C are read to determine the amount of rotational deviation θ. Such an amount of rotational deviation is determined by a not-illustrated calculation unit.

If an image sensor 8 is indivisible in the non-measurement direction (x direction) such as a line sensor, a plurality of image sensors 8 may be prepared to constitute an optical system that can measure in respective positions. A diaphragm may be arranged on an intermediate image plane of an optical system so that a measurement location can be switched to a desired position. Alternatively, the scope 6 may be driven to detect light intensities in areas corresponding to the positions A and C.

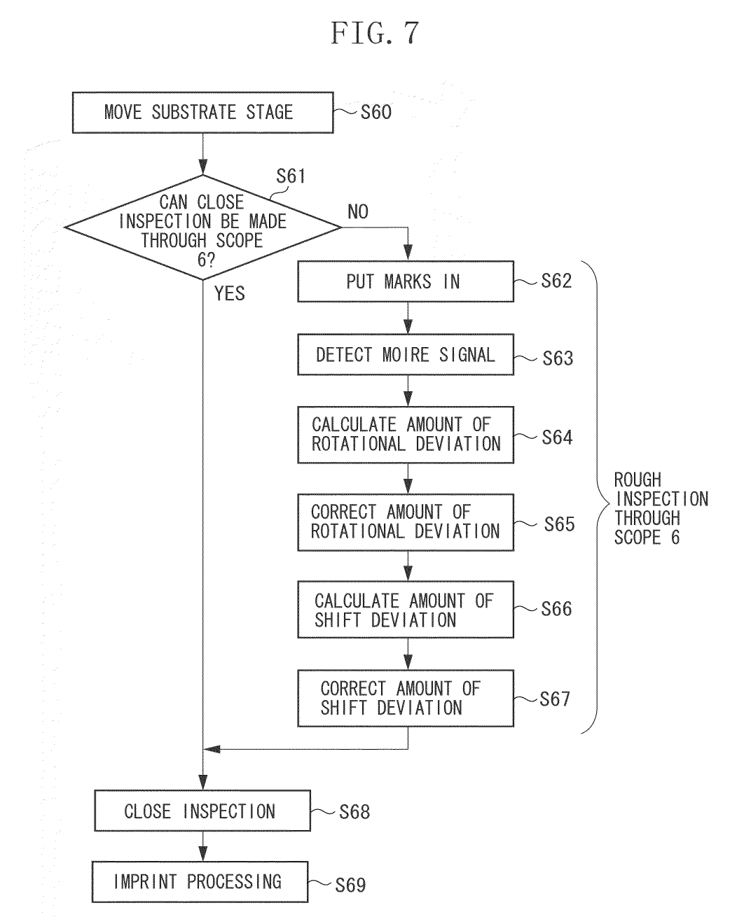

FIG. 7 is a flowchart illustrating a sequence for performing alignment between a mold 2 and a substrate 1 by using the method described above.

Resin, a transfer material, is initially applied to a shot on a substrate 1 by a not-illustrated application mechanism. In step S60, the imprint apparatus drives and moves the substrate stage 12 holding the substrate 1 to under the imprint head 3 in order to measure a positional shift between the resin-applied shot and the mold 2.

After the movement, then in step S61, the imprint apparatus observes a mark 4 on the mold 2 and a mark 5 on the substrate 1 through a scope 6. The imprint apparatus determines whether a close inspection can be made. A close inspection includes high-precision alignment between the mark 4 on the mold 2 and the mark 5 on the substrate 1. If the imprint apparatus determines that a close inspection cannot be made (NO in step S61), the imprint apparatus performs a rough inspection through the scope 6. Typically, there are provided rough inspection marks intended for a rough inspection aside from the marks 4 and 5, and the imprint apparatus performs alignment so that a close inspection can be performed.

If the amount of rotational deviation is high as illustrated in FIG. 5A, it is difficult to measure a plurality of marks 4 and 5 simultaneously. In step S62, the imprint apparatus then puts a pair of mark 4 and 5 into a measurement range based on information on rough inspection marks. By putting a pair of marks 4 and 5 into the measurement range, in step S63, the imprint apparatus enables to detect a moiré signal produced by the marks 4 and 5. In step S64, a not-illustrated calculation unit calculates the amount of rotational deviation between the mold 2 and the shot on the substrate 1 from the detected moiré signal based on the foregoing equations (1) and (2). In step S65, the imprint apparatus rotates the substrate 1 or the mold 2 to correct the amount of rotational deviation based on the amount of rotational deviation calculated.

After the correction of the amount of rotational deviation, then in step S66, the imprint apparatus detects a moiré signal and calculates the amount of positional shift. In step S67, the imprint apparatus shifts and moves at least either one of the substrate 1 and the mold 2 to correct the amount of positional shift between the mold 2 and the substrate 1 based on the amount of positional shift calculated.

If in step S61 a close inspection is determined to be possible (YES in step S61) or when alignment in the rough inspection through the scope 6 ends, then in step S68, the imprint apparatus performs a close inspection through the scope 6. For example, the imprint apparatus may perform a close inspection by performing the calculation and correction of the amount of rotational deviation and the amount of positional shift, which are performed on a pair of marks 4 and 5 in a rough inspection, on a plurality of pairs of marks 4 and 5 for improved precision. Since the procedure for the calculation and correction of the amount of rotational deviation and the calculation and correction of the amount of positional shift is similar to that of steps S63 to S67, description thereof will be omitted.

Such corrections are not always possible. For example, the imprint apparatus may calculate the amount of rotational deviation between the substrate stage 12 and the mold 2 before mounting a substrate 1 on the substrate stage 12 based on the amount of rotational deviation calculated. In such cases, the imprint apparatus can manage the amount of rotational deviation as an offset and thereby correct the amount of rotational deviation between a shot and the mold 2. If a close inspection and/or rough inspection fail(s) to make a satisfactory correction, the imprint apparatus may perform a close inspection and/or rough inspection again.

After alignment up to necessary precision, then in step S69, the imprint apparatus performs actual imprint processing. Instead of actual imprint processing, the imprint apparatus may perform calibration processing using the measurements.

If a plurality of marks 4 and 5 are formed on the mold 2 and the substrate 1, the imprint apparatus aligns the mold 2 and the substrate 1 so that two closest marks 4 and 5 overlap. The imprint apparatus controls the substrate stage 12 so that a closest pair of marks 4 and 5 overlap. Such an operation can reduce the time to put marks 4 and 5 in so that a close inspection can be made. Reducing the time for putting-in increases throughput.

The present exemplary embodiment has dealt mainly with a positional deviation between marks 4 and 5. However, the present exemplary embodiment is also applicable to the case of measuring the positions of a reference mark 11 and a mark 4 formed on the mold 2 like the foregoing baseline measurement. A rotational deviation (positional deviation) between the reference mark 11 and the mark 4 formed on the mold 2 can be corrected for baseline measurement.

As described above, since the amount of rotational deviation (angular deviation) between the mold 2 and the substrate 1 can be determined by detecting interference fringes produced by an overlapping between grating marks 4 and 5, it is possible to reduce the measurement time. Further, the use of grating marks enables the use of a low-resolution scope.

A third exemplary embodiment will be described. The present exemplary embodiment deals with a case where a mark 4 includes three rows of marks illustrated in FIG. 4A with respective different mark pitches. When the mark 4 is to be obliquely detected by the scope 6, the three rows of marks are each configured as illustrated in FIG. 4E described in the second exemplary embodiment.

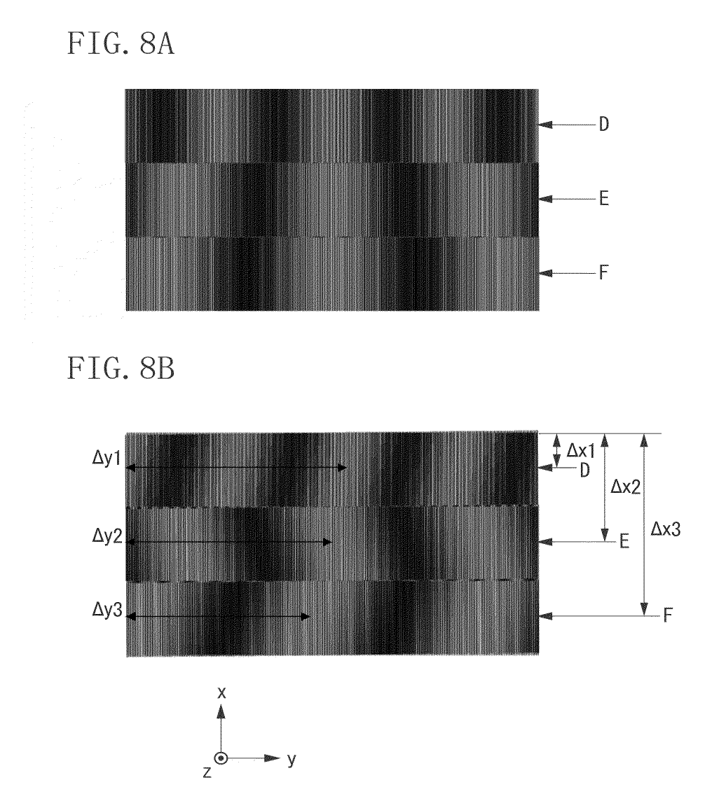

FIGS. 8A and 8B illustrate moiré signals detected when three rows of one-dimensional marks are used as one mark. FIG. 8A illustrates moiré signals that are detected when the mark 4 formed on the mold 2 and a mark 5 formed on the substrate 1 have no shift deviation in an xy plane and no rotational deviation. The three rows of marks, i.e., the marks in the top row, middle row, and bottom row have different mark pitches and thus produce interference fringes of different interference patterns. In the present exemplary embodiment, the interference fringes produced by the three rows of marks have respective different light and dark intervals in light intensity.

FIG. 8B illustrates moiré signals that are detected when the amount of positional shift between the marks 4 and 5 in the y direction is y and the amount of rotational deviation is θ. Again, the three rows of marks are formed with respective different mark pitches. The amounts of shift deviation Δy₁, Δy₂, and Δy₃ of the moiré signals in the y direction in the respective rows are expressed by the following equations (3):

Δy₁=α(y+Δx₁×tan θ)

Δy₂=β(y+Δx₂×tan θ)

Δy₃=γ(y+Δx₃×tan θ) (3)

Where α, β, and γ are moiré magnifications determined by the mark pitches in the measurement direction of the respective rows. The moiré magnifications can be determined by using the foregoing equation (1). Δx₁, Δx₂, and Δx₃ are measurement positions in the x direction in positions D, E, and F. While the present exemplary embodiment deals with the case where the upper end of the three rows of marks is used as a reference, any position may be selected as the reference. For ease of understanding, the left end of the detection range is used as a reference for Δy₁, Δy₂, and Δy₃. However, any position may be selected as the reference. Differences between the amounts of shift deviation of the respective rows (Δy₁−Δy₂, Δy₂−Δy₃, and Δy₃−Δy₁) can be determined by measuring moiré signals. The amount of positional shift y and the amount of rotational deviation θ between the marks 4 and 5 can thus be determined by means of simultaneous equations with the amount of positional shift y and the amount of rotational deviation θ as variables.

As described above, if there are moiré signals acquired from three or more rows of marks and the rows have respective different mark pitches in the measurement direction, the amount of positional shift and the amount of rotational deviation between a shot on the substrate 1 and the mold 2 can be detected at the same time. To perform such a measurement, there have only to be at least three different moiré magnifications. A mark 4 may have different mark pitches. A mark 5 may have different mark pitches. The mark pitches of marks 4 and 5 may be combined to produce three rows of different moiré magnifications.

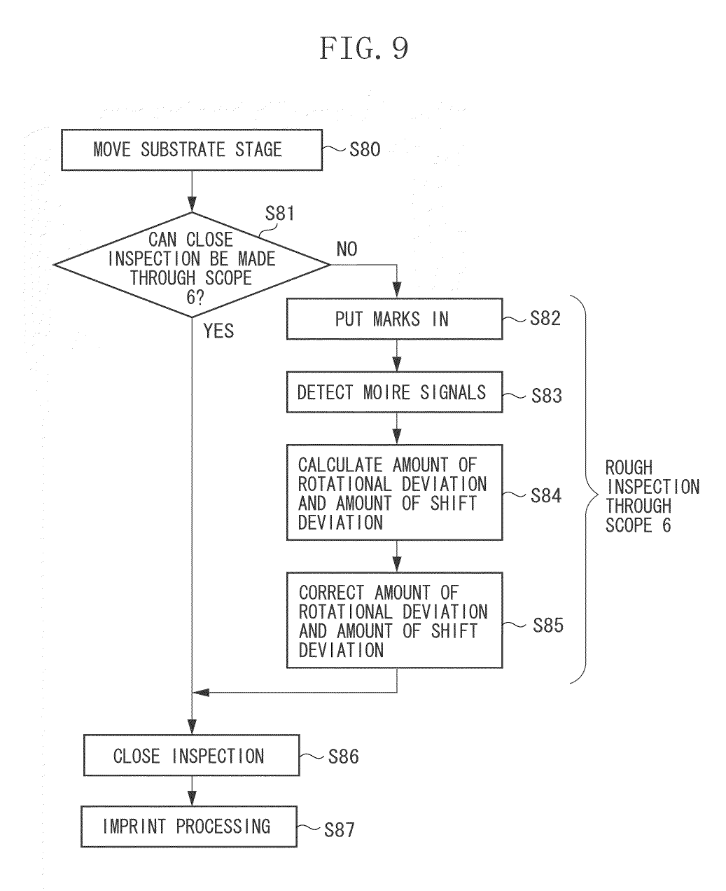

A sequence according to the present exemplary embodiment will be described with reference to the flowchart of FIG. 9. Resin, a transfer material, is applied to a pattern area on a substrate 1 by a not-illustrated application mechanism. In step S80, in order to perform imprinting on a shot on the resin-applied substrate 1, the imprint apparatus moves the shot to under a pattern formed on the mold 2. Specifically, the imprint apparatus drives the substrate 12 holding the substrate 1 to move the shot to be patterned next.

After the movement, then in step S81, the imprint apparatus determines whether a close inspection including high-precision alignment of the mark 4 on the mold 2 and the mark 5 on the substrate 1 can be made. If the imprint apparatus determines that a close inspection cannot be made (NO in step S81), the imprint apparatus performs a rough inspection by using the scope 6. In step S82, similarly to the second exemplary embodiment, the imprint apparatus puts the marks 4 and 5 into a measurement range based on information on rough inspection marks. In step S83, the imprint apparatus detects moiré signals produced from the marks 4 and 5. If the substrate 1 and the mold 2 include a respective plurality of marks 4 and 5, the imprint apparatus puts at least a pair of marks 4 and 5 into a measurement area.

According to the present exemplary embodiment, in step S84, the imprint apparatus can simultaneously calculate the amount of rotational deviation and the amount of positional shift between the mold 2 and the substrate 1 from the result of mark detection. The amount of rotational deviation and the amount of positional shift need not necessarily be calculated at the same time, and may be calculated separately. In step S85, the imprint apparatus corrects the amount of rotational deviation and the amount of positional shift based on the amount of rotational deviation and the amount of positional shift calculated.

If in step S81 a close inspection is determined to be possible (YES in step S81) or when alignment in the rough inspection through the scope 6 ends, then in step S86, the imprint apparatus performs a close inspection through the scope 6. Similarly to the second exemplary embodiment, the imprint apparatus may perform a close inspection, for example, by performing the calculation of the amount of rotational deviation and the amount of positional shift on a plurality of pairs of marks 4 and 5 in step S84 for the sake of improved precision. After alignment up to necessary precision, then in step S87, the imprint apparatus performs actual imprint processing. Instead of actual imprint processing, the imprint apparatus may perform calibration processing using the measurements.

The present exemplary embodiment has dealt with three rows of respective different mark pitches. Various methods may be used for implementation. In one method, three rows of grating marks having respective different intervals may be formed on either one of the substrate 1 and the mold 2 while the other has only one grating mark having an interval different from those of the three rows of grating marks. What is needed at least to perform measurement according to the present exemplary embodiment is that the three moiré magnifications determined by equation (1) are different from each other.

The third exemplary embodiment applies as far as moiré signals with three different moiré magnifications are detected. The present exemplary embodiment has been described in conjunction with the use of three rows of grating marks as illustrated in FIGS. 8A and 8B. The number of rows may be at least three. Four or more rows of grating marks may be used. The precision of the amount of rotational deviation and the amount of positional shift calculated improves with the increasing number of moiré signals having different moiré magnifications.

All the foregoing exemplary embodiments have dealt with the case of determining the amount of deviation including the amount of rotational deviation and the amount of positional shift between marks 4 and 5 and measuring the amount of relative deviation with respect to a shot at the time of imprinting. Aside from the mark measurement in the vicinity of a shot, an exemplary embodiment of the present invention may be applied to when the imprint apparatus measures a reference mark 11 formed on a reference plate on the substrate stage 12 as with baseline measurement. In some cases, the imprint apparatus may calculate the amount of rotational deviation between the substrate stage 12 and the mold 2 before mounting a substrate 1 on the substrate stage 12 based on the amount of rotational deviation calculated. The imprint apparatus need not make corrections based on the calculations but may manage the amount of rotational deviation as an offset and thereby correct the amount of rotational deviation between a shot and the mold 2. If a close inspection and/or rough inspection fail(s) to make a satisfactory correction, the imprint apparatus may perform a close inspection and/or rough inspection again.

The foregoing exemplary embodiments have also dealt with the method of determining the amount of rotational deviation between the mark formed on the mold and the mark formed on the substrate or the reference plate by using one scope. Detecting a moiré signal enables detection of an abnormal value in the amount of rotation of the scope. A method of determining the amount of rotation of the scope (image sensor) from a moiré signal detected by the image sensor will be described below.

For example, suppose that eight pairs of marks 4 and 5 are formed in corresponding positions of a substrate 1 and a mold 2 as illustrated in FIG. 5A. In such a case, the imprint head 3 includes eight scopes 6 for detecting the respective pairs of marks 4 and 5. The imprint apparatus determines the amounts of rotational deviation between the respective pairs of marks 4 and 5 from the moiré signals detected by all the scopes 6 while moiré signals from the marks 4 and 5 can be detected. The method for determining the amount of rotation from a moiré signal may be any one of those of the foregoing exemplary embodiments.

The amounts of rotation detected by all the scopes 6 include the amounts of rotation of the respective scopes 6 aside from the amount of rotation between the mold 2 and the substrate 1. The reason is that each individual scope 6 has an amount of rotation due to an attachment error of the scope 6. As employed herein, the amount of rotation of the scope 6 refers to the amount of rotation of the scope 6 in the x direction or y direction with reference to the imprint apparatus. The amounts of rotation determined from the moiré signals detected by the respective scopes 6 can differ from one scope to another. The amounts of rotation determined by using the scopes 6 are therefore averaged to determine the amount of rotation between the mold 2 and the substrate 1.

If the plurality of scopes 6 includes one or more scopes 6 that have a high attachment error, such a scope (s) 6 can affect the average amount of rotation and make it not possible to determine the amount of rotational deviation with high precision. Then, after the determination of the average amount of rotation, the imprint apparatus compares the amounts of rotation obtained from the respective scopes 6 with the average value. A scope or scopes 6 that go out of a range of desired allowable values about the average may be considered to have some defects since their measurements are far from those of the other scopes 6. The desired allowable values may be the average amount of rotation multiplied by allowable ratios of variation. The user may set desired values as the allowable ratios based on the measurement precision and past records of the scopes 6. Scopes 6 that go out of the range of the average±allowable values of variation are determined to be defective. It is better not to include the value of the scope to be evaluated in values taken as the average, since the value of the scope can be compared as an irrelevant data. For example, there is a difference in value between the average of all the eight scopes and the average of the seven scopes excluding the scope to be evaluated. The difference is the value related to the scope to be evaluated. Consequently, it is considered easier to find defects when operation of comparison between the seven scopes excluding the scope to be evaluated and the scope to be evaluated is performed.

If any defective scope 6 is included, for example, the imprint apparatus determines the average amount of rotation again, excluding the amount (s) of rotation determined from the defective scope (s) 6. The amounts of rotation within desired allowable values can be used to determine the amount of rotation between the mold 2 and the substrate 1 with high precision. A difference between the average amount of rotation and the amount of rotation of a defective scope 6 may be stored into the control unit 13 of the imprint apparatus as an offset (amount of attachment error). The amount of rotation is determined by reflecting offset when the imprint apparatus determines the amount of rotation from a moiré signal that is determined by the defective scope 6.

As described above, moiré signals can be used as an index for close examination on the attachment errors of the scopes 6. The present technique needs no particular measurement for determining the attachment errors of the scopes 6. Such a technique is useful for daily abnormal value detection since the technique can be implemented by using alignment measurements in ordinary manufacturing processes.

All the foregoing exemplary embodiments have dealt with a light cure method of using a resin that cures when irradiated with light. The imprint method is not limited to the photo-curing method, and imprinting may be performed by using a heat cycle method of using a thermoplastic resin for pattern formation. In such a case, the input apparatus includes a heat source such as a heater in the imprint head 3 and/or the substrate stage 12 in order to heat the resin. According to the heat cycle method, the imprint apparatus heats a thermoplastic imprint resin to or above glass transition temperature, and presses the mold 2 against a substrate 1 with the resin of increased fluidity therebetween. After cooling, the imprint apparatus releases the mold 2 from the resin, whereby a pattern is formed.

The foregoing exemplary embodiments of the present invention have dealt with a detection apparatus that is used in an imprint apparatus. However, a detection apparatus according to an exemplary embodiment of the present invention is not limited in application to an imprint apparatus. A detection apparatus according to an exemplary embodiment of the present invention may be used for any apparatus that detects marks formed on two respective different objects and determines the amount of rotational deviation between the two different objects.

A method for manufacturing a device (such as a semiconductor integrated circuit element and a liquid crystal display element) includes forming a pattern on a substrate (wafer, glass plate, or film-like substrate) by using the foregoing imprint apparatus. The method for manufacturing a device may include etching the substrate on which the pattern is formed. When manufacturing other objects such as a patterned medium (recording medium) and an optical element, the manufacturing method may include other processes for processing the substrate on which the pattern is formed, instead of etching. A method for manufacturing an object according to the present exemplary embodiment is advantageous in at least one of performance, quality, productivity, and production cost of an object as compared to conventional methods.

Exemplary embodiments of the present invention have been described above. The present invention is not limited to such exemplary embodiments, and various combinations, alterations, and modifications may be made without departing from the gist of the invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-105633 filed May 10, 2011, which is hereby incorporated by reference herein in its entirety.

What is claimed is:

1. A detection apparatus configured to determine an amount of relative rotational deviation between two different objects, each of the objects having a respective grating mark which together form a pair of grating marks, the detection apparatus comprising:
a detector configured to detect interference fringes produced by an overlap between the pair of grating marks; and
a calculation unit configured to determine the amount of relative rotational deviation between the two different objects from inclination of the interference fringes detected by the detector.

2. The detection apparatus according to claim 1, wherein the pair of grating marks are formed of a plurality of lines at intervals different from each other.

3. The detection apparatus according to claim 2, wherein the amount of rotational deviation between the two different objects is determined by detecting at least either one of a peak portion and a bottom portion of light intensity of the interference fringes from a detection area of the interference fringes detected by the detector.

4. The detection apparatus according to claim 3, wherein an amount of deviation of the interference fringes in a direction of a line of the grating marks and an amount of deviation of the interference fringes in a direction perpendicular to the direction of the line are determined from the light intensity of the interference fringes detected by the detector,
an inclination angle is determined from a right triangle with two sides which are formed of the amount of deviation of the interference fringes in the direction of the line and the amount of deviation of the interference fringes in the direction perpendicular to the direction of the line, and the amount of rotational deviation between the two different objects is determined from the inclination angle.

5. The detection apparatus according to claim 2, wherein the pair of grating marks overlap to form three separate rows of interference fringes having interference patterns different from one another, the three separate rows of interference fringes are individually detected to determine respective amounts of deviation of the detected interference fringes, and an amount of positional shift and the amount of rotational deviation between the two different objects are determined from the determined amounts of deviation of the interference fringes.

6. The detection apparatus according to claim 5, wherein either one of the pair of grating marks is formed of three separate rows, each of the three separate rows formed of a plurality of lines at a regular interval, and the plurality of lines is formed having intervals different from one another, and
wherein the other of the pair of grating marks formed of lines at an interval different from the plurality of lines formed in each of the three separate rows.

7. The detection apparatus according to claim 1, further comprising a plurality of the detectors, wherein the plurality of the detectors detect each of a plurality of interference fringes occurring from an overlap between a plurality of pairs of grating marks formed in positions corresponding to the two different objects, respectively, and
wherein the calculation unit determines the amount of rotation of the detector from the amount of relative rotational deviation between the two different objects determined from the inclination of a plurality of the interference fringes.

8. An imprint apparatus configured to form a pattern by transferring a pattern formed on a mold to a transfer material applied to a substrate, the imprint apparatus comprising
control unit configured to provide data for controlling transfer of the pattern to the transfer material, and
a detection apparatus configured to determine an amount of relative rotational deviation between two different objects, each of the objects having a respective grating mark which together form a pair of grating marks, the detection apparatus comprising:
a detector configured to detect interference fringes produced by an overlap between the pair of grating marks; and
a calculation unit configured to determine the amount of relative rotational deviation between the two different objects from inclination of the interference fringes detected by the detector,
wherein the detection apparatus is configured to determine an amount of relative rotational deviation between the mold and the substrate by detecting the pair of grating marks, either one of the pair of grating marks formed on the mold, the other of the pair of grating marks formed on the substrate.

9. The imprint apparatus according to claim 8, wherein the imprint apparatus is configured to correct relative rotational deviation between the mold and the substrate based on the amount of rotational deviation between the mold and the substrate determined by detecting the pair of grating marks, or manage the amount of rotational deviation as an offset to perform imprinting.

10. The imprint apparatus according to claim 8, wherein a third grating mark formed of a plurality of lines at an interval different from those of the pair of grating marks is formed on a reference plate arranged on a substrate stage configured to hold the substrate, and the detector detects interference fringes produced by an overlap between the third grating mark and the grating mark formed on the mold to determine a positional deviation between the mold and the reference plate.

11. A method for manufacturing a device, comprising:
forming a pattern on a substrate by using an imprint apparatus; and
processing the substrate on which the pattern is formed according to the forming operation,
wherein the imprint apparatus is configured to form a pattern by transferring a pattern formed on a mold to a transfer material applied to a substrate, the imprint apparatus comprising
a detection apparatus configured to determine an amount of relative rotational deviation between two different objects, each of the objects having a respective grating mark which together form a pair of grating marks, the detection apparatus comprising:
a detector configured to detect interference fringes produced by an overlap between the pair of grating marks; and
a calculation unit configured to determine an amount of relative rotational deviation between the two different objects from inclination of the interference fringes detected by the detector,
wherein the detection apparatus is configured to determine an amount of relative rotational deviation between the mold and the substrate by detecting the pair of grating marks, either one of the pair of grating marks formed on the mold, the other of the pair of grating marks formed on the substrate.

12. A detection method for determining an amount of relative rotational deviation between two different objects, each of the objects having a respective grating mark which together form a pair of grating marks, the detection method comprising
detecting interference fringes produced by an overlap between the pair of grating marks, and determining the amount of relative rotational deviation between the two different objects from inclination of the interference fringes detected by the detector.
